(19) United States
(12) Patent Application Publication
(10) Pub. No.: US 2014/0379204 A1
(43) Pub. Date: Dec. 25, 2014

(54) Diagnostic Device of RD Converter, Steering System, and Power Train System

(71) Applicant: Hitachi Automotive Systems, Ltd., Hitachinaka-shi, Ibaraki (JP)

(72) Inventors: Kosei Goto, Hitachinaka (JP); Satoru Shigeta, Hitachinaka (JP); Yukihiko Ooishi, Hitachinaka (JP)

(21) Appl. No.: 14/370,525

(22) PCT Filed: Nov. 28, 2012
(86) PCT No.: PCT/JP2012/080662

§ 371 Date: Jul. 3, 2014

(30) Foreign Application Priority Data
Jan. 4, 2012 (JP) 2012-000105

(51) Int. Cl. G07C 5/08; B60L 3/12; B62D 5/04

(52) U.S. Cl. CPC G07C 5/0808; B62D 5/0487; B60L 3/12
USPC 701/31.7

(57) ABSTRACT

To diagnose whether a diagnostic function inside an RD converter is normally operated with a simple configuration even if abnormality occurs in the RD converter itself.

A diagnostic device of an RD converter diagnostic unit according to the present invention generates and inputs a resolver output that is in an error state to an RD converter, and determines that the diagnostic unit is normally operated if a diagnosis result of the RD converter indicates an abnormal state.

### TECHNICAL FIELD

The present invention relates to a technology to diagnose whether a diagnostic unit is normally operated, the diagnostic unit diagnosing a resolver/digital converter (RD converter) that calculates a detection angle of a resolver using output signals of the resolver.

### BACKGROUND ART

A resolver is a device mounted on a rotating body, such as a motor, and which detects a rotating angle of the rotating body. Typically, the resolver expresses a detection angle thereof by periodic output signals having mutually different phases, such as a sin wave and a cos wave. An RD converter receives the output signals from the resolver, calculates a rotating angle and an angle speed of the resolver using the output signals, and outputs a calculation result to a microcomputer that performs motor control.

The RD converter typically includes following abnormality detection functions (diagnostic functions) in its inside or outside. When a diagnostic unit has detected any abnormality, the RD converter outputs an error signal according to each abnormality state to the microcomputer.

(Diagnostic Function 1) Detection and diagnosis of abnormality of an angle/angle speed calculation unit inside an RD converter

(Diagnostic Function 2) Detection and diagnosis of abnormality of input signals (output signals from a revolver) to an RD converter

The diagnostic function 1 determines that, when an error between a resolver detection angle calculated by an angle/angle speed calculation unit inside an RD converter based output signals of a resolver and a detection angle predicted by the diagnostic function 1 itself exceeds a predetermined threshold, the angle/angle speed calculation unit has abnormality.

The diagnostic function 2 detects whether output signals output from the resolver is normal. For example, when a maximum amplitude value of the output signals exceeds a predetermined threshold, or when the maximum amplitude of the output signals is smaller than a predetermined threshold, the diagnostic function 2 determines that the input signals (the output signals from the resolver) to the RD converter has abnormality.

In a system that performs motor control, such as a hybrid vehicle or an electric power steering system, when the microcomputer has detected an error signal from an abnormality detection function (diagnostic function) of the system, the microcomputer stops the motor control by immediately stopping a PWM output, or the like.

However, the above-described diagnostic function can be used only when the RD converter itself is normally operated. When abnormality occurs inside the RD converter, there is a possibility that soundness of the diagnostic function is impaired, and a diagnosis result thereof is not credible.

In PTL 1 below, an RD converter itself has a self-diagnostic function. To be specific, the paragraph 0024 of PTL 1 describes, when a self-diagnosis instruction is input to the RD converter from an outside, the RD converter itself inputs a simulation signal in an abnormal state to a diagnostic unit in its inside, and diagnoses soundness of whether the diagnostic unit correctly detects an error.

In PTL 2 below, a technique is described, in which an input signal to an RD converter is also input to a microcomputer, and abnormality of a signal status is detected based on an amplitude or a locus of the input signal at the microcomputer side. By use of the technology, a redundant system function can be included, which compares whether the RD converter has similarly detected the abnormality when the microcomputer has detected the signal status is abnormal. Accordingly, whether the diagnostic function inside the RD converter is normally operated can be determined.

### CITATION LIST

### Patent Literature

PTL 1: Publication of U.S. Pat. No. 4,126,701

PTL 2: Publication of U.S. Pat. No. 4,155,465

### SUMMARY OF INVENTION

### Technical Problem

In the technology described in PTL 1 above, when a simulation signal generation unit inside the RD converter or the RD converter itself has abnormality, the soundness of the self-diagnostic function may be impaired. That is, the RD converter merely performs self-diagnosis. Therefore, there is a possibility that, if the RD converter itself has abnormality, the self-diagnostic function may also not be normally operated.

In the technology described in PTL 2 above, it is necessary to redundantly implement a diagnostic logic similar to the diagnostic function inside the RD converter on software of the microcomputer. Thus, complexity of the software is caused and throughput is increased. Further, whether the diagnostic function inside the RD converter is normally operated is first determined when an error state has actually occurred.

The present invention has been made in view of the above problems, and an objective is to diagnose whether a diagnostic function inside an RD converter is normally operated with a simple configuration even if abnormality occurs in the RD converter itself.

### Solution to Problem

A diagnostic device of an RD converter diagnostic unit according to the present invention generates and inputs a resolver output that is in an error state to an RD converter, and determines that the diagnostic unit is normally operated if a diagnosis result of the RD converter indicates an abnormal state.

### Advantageous Effects of Invention

According to a diagnostic device of an RD converter diagnostic unit of the present invention, even when the RD converter itself is in an abnormal state, whether the self-diagnostic function of the RD converter is normally operated can be diagnosed without being influenced by the abnormal state. Further, it is not necessary to perform the same diagnosis as the self-diagnostic function of the RD converter. Therefore, the above effects can be exerted with a simple configuration.

### BRIEF DESCRIPTION OF DRAWINGS

FIG. 1 is a configuration diagram of a rotating angle detection system 100 according to a first embodiment.

FIG. 2 is a diagram exemplarily illustrating an excitation input signal 211 and output signals of a resolver 30.

FIG. 3 is a diagram illustrating waveform examples of error state signals generated by an error state signal generation unit 11 when whether a calculation function diagnostic unit 25 is normally operated is diagnosed.

FIG. 4 is a diagram illustrating waveform examples of error state signals generated by the error state signal generation unit 11 when an input signal diagnostic unit 23 is normally operated is diagnosed.

FIG. 5 is a diagram illustrating waveform examples of error state signals generated by the error state signal generation unit 11 when an input signal diagnostic unit 23 is normally operated is diagnosed.

FIG. 6 is a flowchart describing a procedure of diagnosing a self-diagnostic function of an RD converter 20 by a diagnostic device 10.

FIG. 7 is a configuration diagram of an electric vehicle 1000 according to a third embodiment.

### DESCRIPTION OF EMBODIMENT

### First Embodiment

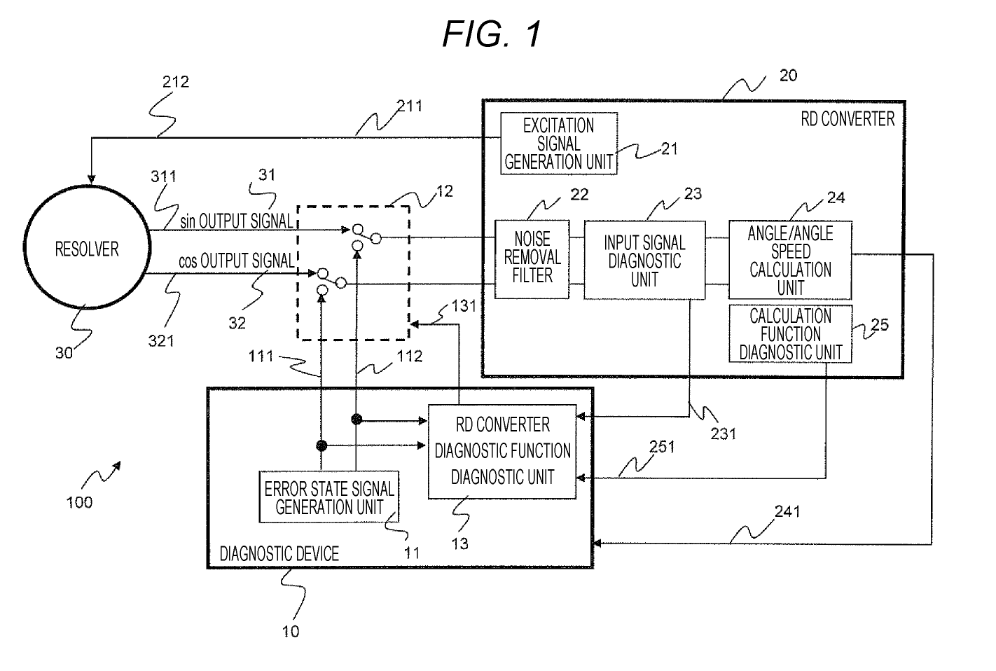

FIG. 1 is a configuration diagram of a rotating angle detection system 100 according to a first embodiment of the present invention. The rotating angle detection system 100 is a system that detects a rotating angle of a rotating body, such as a motor, and includes a diagnostic device 10, an RD converter 20, and a resolver 30.

The resolver 30 is mounted on the rotating body (for example, a motor) that is an object from which a rotating angle is detected. An excitation input signal 211 is input from an excitation signal generation unit 21 in the RD converter 20 to the resolver 30 through an excitation signal line 212. The excitation signal line 212 is typically configured from a twin wire type of a reference voltage line and an excitation signal line. The excitation input signal 211 is a sine wave of 10 to 20 kHz, for example.

The resolver 30 expresses a detection result of a rotating angle by a sin output signal 31 and a cos output signal 32, and outputs the output signals to the RD converter 20. The sin output signal 31 and the cos output signal 32 are input to the RD converter 20 through a sin output signal line 311 and a cos output signal line 321, respectively, and through a fault injection unit 12.

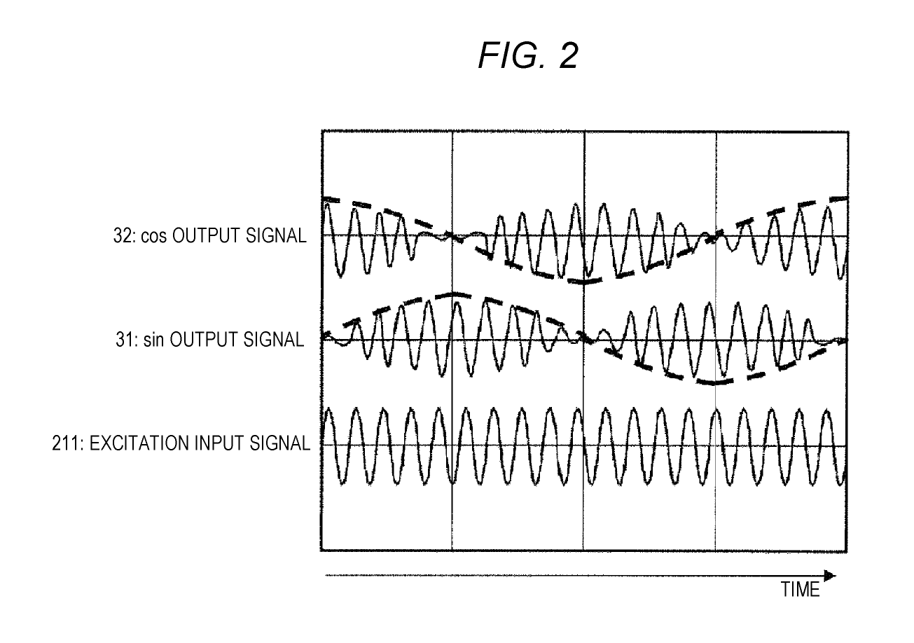

The sin output signal line 311 is configured from twin wire connected to a sin winding output terminal of the resolver 30, and the cos output signal line 321 is configured from twin wire connected to a cos winding output terminal of the resolver 30. The sin output signal 31 and the cos output signal 32 are voltages evoked in the resolver 30 based on the excitation input signal 211. Waveforms of the sin output signal 31 and the cos output signal 32 are a sin wave and a cos wave in which an amplitude is constant during stop of the motor, and are envelope waveforms of a sin wave and a cos wave during rotation of the motor, as illustrated in FIG. 2.

The RD converter 20 is a device that calculates a detection angle of the resolver 30 using an output of the resolver 30, and includes the excitation signal generation unit 21, a noise removal filter 22, an input signal diagnostic unit 23, an angle/angle speed calculation unit 24, and a calculation function diagnostic unit 25.

The noise removal filter 22 is a low-pass filter that removes a high-frequency noise from a signal input through the fault injection unit 12. The input signal diagnostic unit 23 diagnoses whether a signal from which a noise has been removed by the noise removal filter 22 is normal, and outputs a diagnosis result 231 thereof to the diagnostic device 10. An example of a diagnosis performed by the input signal diagnostic unit 23 will be described below.

The angle/angle speed calculation unit 24 receives the output signals of the resolver 30 through the input signal diagnostic unit 23, and calculates a rotating angle and an angle speed detected by the resolver 30 using the output signals. A calculation result 241 is output to the diagnostic device 10.

The calculation function diagnostic unit 25 estimates a calculation result 241 of the angle/angle speed calculation unit 24 separately from an operation of the angle/angle speed calculation unit 24 by a technique of adding up angle speeds calculated by the angle/angle speed calculation unit 24, or the like. The calculation function diagnostic unit 25 diagnoses whether the angle/angle speed calculation unit 24 is normally operated by determining whether the prediction result is equal to or larger than a predetermined threshold, and is separated from the calculation result 241. The calculation function diagnostic unit 25 outputs a diagnosis result 251 to the diagnostic device 10.

The diagnostic device 10 is a device that diagnoses whether the self-diagnostic function of the RD converter 20, that is, the input signal diagnostic unit 23 and the calculation function diagnostic unit 25 are normally operated. The diagnostic device 10 determines whether the diagnostic units are normally operated according to whether the diagnostic units report an abnormal state when an error state signal is input to the RD converter 20.

The diagnostic device 10 includes an error state signal generation unit 11, the fault injection unit 12, and an RD converter diagnostic function diagnostic unit 13. In FIG. 1, the error diagnosis injection unit 12 is illustrated outside the diagnostic device 10 for the purpose of description. However, the location of the error diagnosis injection unit 12 is not limited to the illustration.

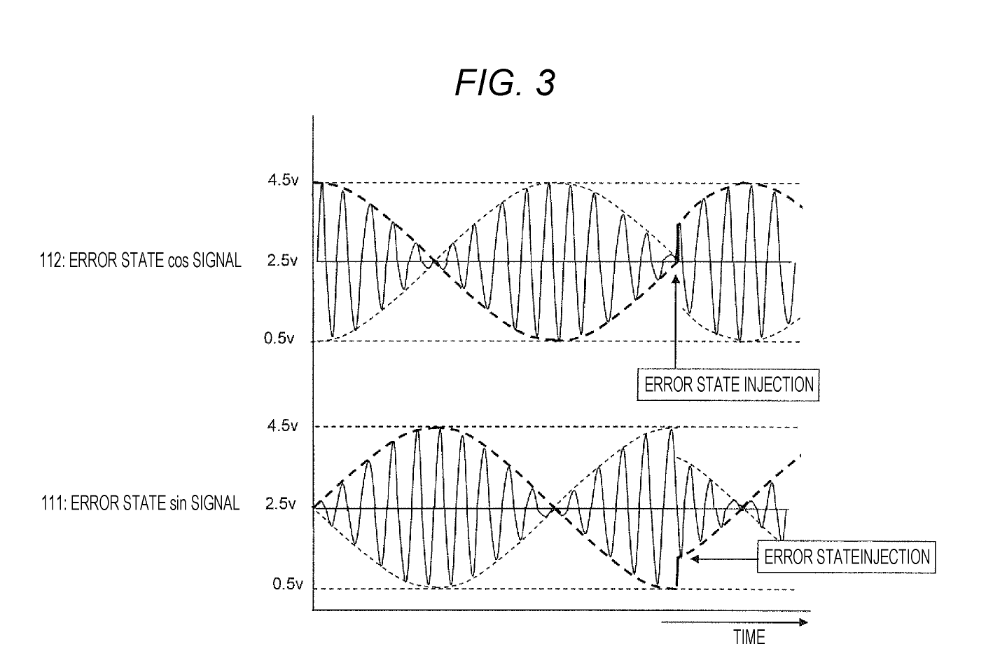

The error state signal generation unit 11 generates the sin output signal 31 and the cos output signal 32 (an error state sin signal 111 and an error state cos signal 112), which have become in an error state, exemplarily illustrated in FIGS. 3 to 5 below.

The fault injection unit 12 switches whether the sin output signal 31 and the cos output signal 32 are input to the RD converter 20 and whether the error state sin signal 111 and the error state cos signal 112 are input to the RD converter 20, according to an error injection permission signal 131 from the RD converter diagnostic function diagnostic unit 13.

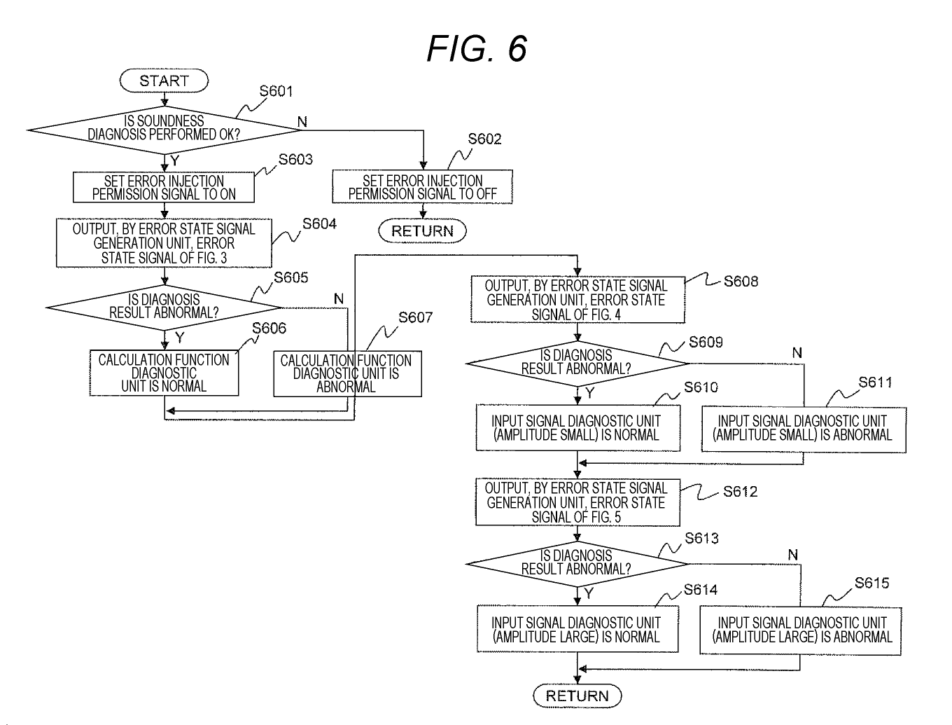

The RD converter diagnostic function diagnostic unit 13 diagnoses whether the input signal diagnostic unit 23 and the calculation function diagnostic unit 25 are normally operated based on the diagnosis results 231 and 251. When performing these diagnoses, the RD converter diagnostic function diagnostic unit 13 outputs the error injection permission signal 131 to the fault injection unit 12, and performs diagnostic processing described in FIG. 6 below. When the error injection permission signal 131 is ON, the fault injection unit 12 inputs the error state sin signal 111 and the error state cos signal 112 to the RD converter 20, and when the error injection permission signal 131 is OFF, the fault injection unit 12 inputs the sin output signal 31 and the cos output signal 32 to the RD converter 20.

Function units included in the diagnostic device 10 and the RD converter 20 can be configured from hardware, such as a circuit device that realizes these functions, or can be configured from software that incorporates similar functions and a calculation unit that executes the software.

FIG. 2 is a diagram exemplarily illustrating the excitation input signal 211 and output signals of the resolver 30. As illustrated in FIG. 2, signals obtained by connecting maximum amplitude values of the sin output signal 31 and the cos output signal 32 are called envelope signals, or the like. The envelope signal has a waveform periodically changing in a sine wave manner.

A configuration of the rotating angle detection system 100 has been described above. Next, a technique of diagnosing a self-diagnostic function of an RD converter by the diagnostic device 10 will be described.

The input signal diagnostic unit 23 diagnoses the states of the respective envelope signals of the sin output signal 31 and the cos output signal 32. Main diagnoses are following two examples.

### (A Diagnosis, Part 1, Performed by the Input Signal Diagnostic Unit 23)

When an amplitude value of the envelope signal (a maximum amplitude value of the output signal of the resolver 30) is smaller than a minimum threshold value set in the RD converter 20 in advance, the input signal diagnostic unit 23 determines that the output signal is abnormal, and outputs the diagnosis result 231 indicating the fact of the abnormality to the diagnostic device 10. The input signal diagnostic unit 23 may separately notify the diagnosis results 231 regarding the respective envelope signals of the sin output signal 31 and the cos output signal 32, or may determine that the output signals of the resolver 30 as a whole are abnormal if at least one of the envelope signals has abnormality. The same applies to a diagnosis, part 2 below.

### (A Diagnosis, Part 2, Performed by the Input Signal Diagnostic Unit 23)

When an amplitude value of the envelope signal (a maximum amplitude value of the output signal of the resolver 30) is larger than a maximum threshold set in the RD converter 20 in advance, the input signal diagnostic unit 23 determines that the output signal is abnormal, and outputs the diagnosis result 231 indicating the fact of the abnormality to the diagnostic device 10.

### (A Supplement: a Diagnosis Performed by the Input Signal Diagnostic Unit 23)

An increase/decrease of the amplitude of the envelope signal is caused by an increase/decrease of a resistance of a signal path from the resolver 30 to the RD converter 20. At the timing before the angle/angle speed calculation unit 24 calculates an angle speed, and the like, existence of abnormality cannot be diagnosed, and therefore, a main object to be diagnosed is the amplitude of the envelope signal.

FIG. 3 is a diagram illustrating waveform examples of error state signals generated by the error state signal generation unit 11 when whether the calculation function diagnostic unit 25 is normally operated is diagnosed. Since the calculation function diagnostic unit 25 predicts a rotating angle and an angle speed calculated by the angle/angle speed calculation unit 24 and compares the predicted rotating angle and angle speed with an actual calculation result. Therefore, if phases of the output signals of the resolver 30 are shifted, a difference between the prediction result and the output signals becomes large, and the angle/angle speed calculation unit 24 is determined to be abnormal.

Therefore, when whether the calculation function diagnostic unit 25 is normally operated is diagnosed, the error state signal generation unit 11 shifts the phases of the output signals of the resolver 30, and thus at least one of the sin output signal 31 and the cos output signal 32 generates an error state that changes in a step manner in place of a periodic change. Accordingly, inconsistency of phases is caused between the sin output signal 31 and the cos output signal 32, and the error state sin signal 111 and the error state cos signal 112, and thus, if the calculation function diagnostic unit 25 is normally operated, the diagnosis result 251 indicating the angle/angle speed calculation unit 24 is abnormal is supposed to be output.

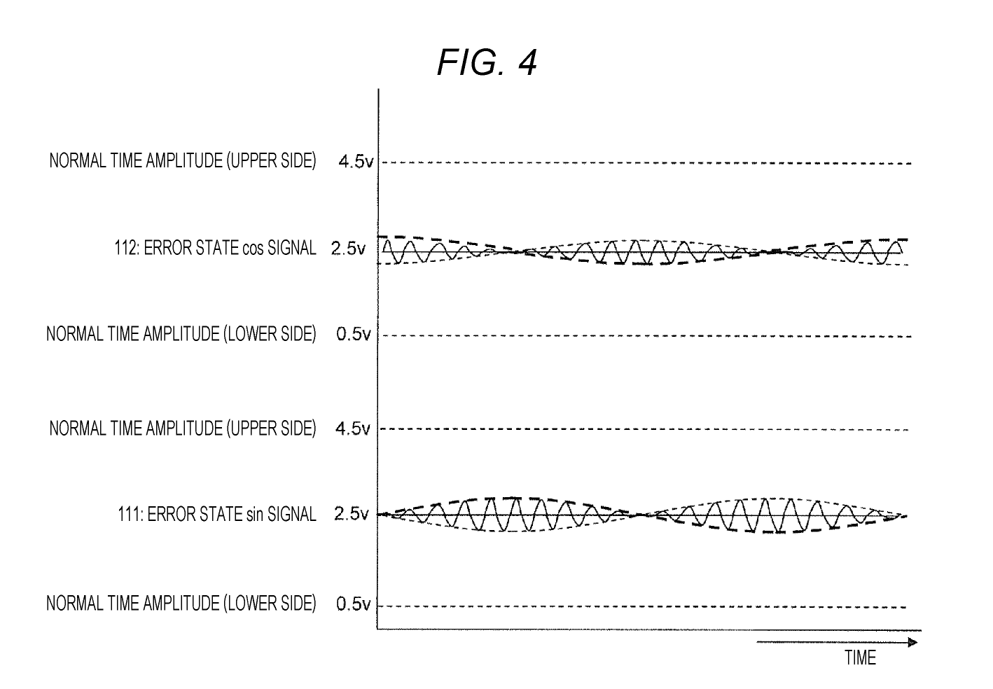

FIG. 4 is a diagram illustrating waveform examples of error state signals generated by the error state signal generation unit 11 when whether the input signal diagnostic unit 23 is normally operated is diagnosed. The waveform examples correspond to the diagnosis, part 1, performed by the input signal diagnostic unit 23 above.

When whether the input signal diagnostic unit 23 is normally operated is diagnosed, the error state signal generation unit 11 makes the amplitude of at least one of the envelope signals of the error state sin signal 111 and the error state cos signal 112 smaller than the minimum threshold value, with which the input signal diagnostic unit 23 detects abnormality.

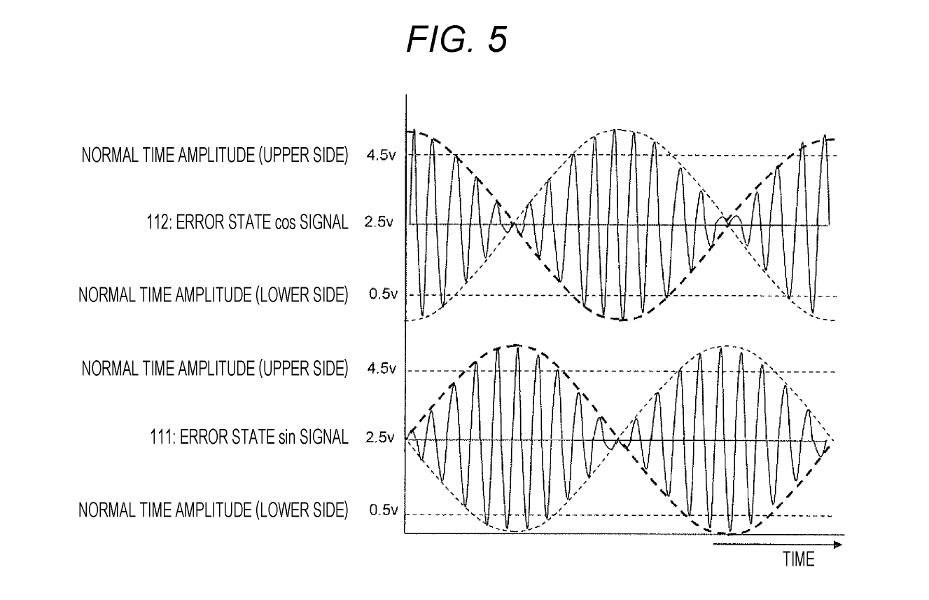

FIG. 5 is a diagram illustrating waveform examples of error state signals generated by the error state signal generation unit 11 when whether the input signal diagnostic unit 23 is normally operated is diagnosed. The waveform examples correspond to the diagnosis, part 2, performed by the input signal diagnostic unit 23 above.

When whether the input signal diagnostic unit 23 is normally operated is diagnosed, the error state signal generation unit 11 makes the amplitude of at least one of the envelope signals of the error state sin signal 111 and the error state cos signal 112 larger than the maximum threshold, with which the input signal diagnostic unit 23 detects abnormality.

The error state signals illustrated in FIG. 5 can be used both of before and after a diagnosis is performed using the error state signals illustrated in FIG. 4. In FIG. 6 below, the diagnosis is first performed using the error state signals of FIG. 4. However, the diagnosis is not limited to the example. Similarly, the error state signals illustrated in FIG. 3 may be used after a diagnosis is performed using the error state signals illustrated in FIGS. 4 and 5.

The error state signals like FIGS. 3 to 5 generated by the error state signal generation unit 11 can be implemented by using a digital/analog conversion (DA) function included in a microcomputer, for example. When the microcomputer does not have the DA function, an external circuit (IC), such as a DA converter, is provided outside the microcomputer, an instruction is given by SPI communication from the microcomputer to the DA converter (IC), and the error state signal may be obtained by the DA converter (IC).

FIG. 6 is a flowchart describing a procedure of diagnosing a self-diagnostic function of the RD converter 20 by the diagnostic device 10. Hereinafter, steps of FIG. 6 will be described.

### (FIG. 6: Step S601)

To diagnoses the self-diagnostic function of the RD converter 20 by the diagnostic device 10, it is necessary to inject an error state signal. Therefore, it is necessary that the motor is completely stopped, and the motor control is not being controlled. For example, the-above conditions are satisfied in an initializing state of startup of the system, when the system is in a shutdown sequence status, in an idling-stop status in a case of a driving system motor of a hybrid vehicle, and the like. The diagnostic device 10 determines whether an object system including the motor is in a state of capable to diagnosing the self-diagnostic function of the RD converter 20 in the present step. When a diagnosis can be performed, the procedure proceeds to step S603, and when a diagnosis cannot be performed, the procedure proceeds to step S602.

### (FIG. 6: Step S602)

The RD converter diagnostic function diagnostic unit 13 sets the error injection permission signal 131 to OFF, and returns to immediately preceding processing without performing a diagnosis.

### (FIG. 6: Step S603)

The RD converter diagnostic function diagnostic unit 13 sets the error injection permission signal 131 to ON, and starts subsequent diagnostic processing.

### (FIG. 6: Steps S604 to S605)

The fault injection unit 12 inputs the error state signal illustrated in FIG. 3 to the RD converter 20 (S604). If the diagnosis result 251 of the calculation function diagnostic unit 25 indicates “abnormality”, the procedure proceeds to step S606, and if the diagnosis result 251 does not indicate “abnormality”, the procedure proceeds to step S607.

### (FIG. 6: Steps S606 to S607)

If the diagnosis result 251 indicates “abnormality”, the RD converter diagnostic function diagnostic unit 13 determines that the calculation function diagnostic unit 25 is “normal (sound)” (S606), and if the diagnosis result 251 does not indicate “abnormality”, the RD converter diagnostic function diagnostic unit 13 determines that the calculation function diagnostic unit 25 is “abnormal (not sound)” (S607).

### (A Supplement: FIG. 6: Steps S606 and S607)

In step S604, the fault injection unit 12 has input the error state signal to the RD converter 20, and thus if the calculation function diagnostic unit 25 is normally operated, the diagnosis result 251 is supposed to indicate “abnormality”. In this step, whether the calculation function diagnostic unit 25 is normally operated is diagnosed based on this approach. Following steps are also based on similar approach.

### (FIG. 6: Steps S608 and S609)

The fault injection unit 12 inputs the error state signal illustrated in FIG. 4 to the RD converter 20 (S608). If the diagnosis result 231 of the input signal diagnostic unit 23 indicates “abnormality”, the procedure proceeds to step S610, and if the diagnosis result 231 does not indicate “abnormality”, the procedure proceeds to step S611.

### (FIG. 6: Steps S610 and S611)

If the diagnosis result 231 indicates “abnormality”, the RD converter diagnostic function diagnostic unit 13 determines that the minimum amplitude diagnostic function of the input signal diagnostic unit 23 is “normal (sound)” (S610), and if the diagnosis result 231 does not indicate “abnormality”, the RD converter diagnostic function diagnostic unit 13 determines that the function of the input signal diagnostic unit 23 is “abnormal (not sound)” (S611).

### (FIG. 6: Steps S612 and S613)

The fault injection unit 12 inputs the error state signal illustrated in FIG. 5 to the RD converter 20 (S612). If the diagnosis result 231 of the input signal diagnostic unit 23 indicates “abnormality”, the procedure proceeds to step S614, and if the diagnosis result 231 does not indicate “abnormality”, the procedure proceeds to step S615.

### (FIG. 6: Steps S614 and S615)

If the diagnosis result 231 indicates “abnormality”, the RD converter diagnostic function diagnostic unit 13 determines that the maximum amplitude diagnostic function of the input signal diagnostic unit 23 is “normal (sound)” (S614), and if the diagnosis result 231 does not indicates “abnormality”, the RD converter diagnostic function diagnostic unit 13 determines that the function of the input signal diagnostic unit 23 is “abnormal (not sound)” (S615).

### (A Supplement: FIG. 6: Steps S601 to S615)

When having determined that at least one of the self-diagnostic functions of the RD converter 20 (the input signal diagnostic unit 23 and the calculation function diagnostic unit 25) is abnormal (not sound), the RD converter diagnostic function diagnostic unit 13 reports the fact of the abnormality to a higher-rank system. Upon receiving the report, the higher-rank system provides for safety of the entire system by executing a failsafe function (a function to forcibly transfer to a safety action, such as stopping of the motor control), for example.

### First Embodiment

### Summary

As described above, the diagnostic device 10 according to the first embodiment inputs the error state signal to the RD converter 20, and diagnoses whether the self-diagnostic unit is normally operated according to whether the self-diagnostic unit of the RD converter 20 detects an error state. Accordingly, the diagnostic device 10 can diagnose the operation of the self-diagnostic unit without being influenced by whether the RD converter 20 itself is normally operated.

Further, according to the diagnostic device 10 of the first embodiment, the self-diagnostic function of the RD converter 20 can be objectively diagnosed. Accordingly, the safety and the reliability of the system that performs the motor control, such as a hybrid vehicle and an electric power steering system, can be improved.

### Second Embodiment

In a second embodiment of the present invention, other diagnoses that can be performed on the assumption of the configuration described in the first embodiment will be described.

### (Another Diagnosis 1: A Diagnosis of a Noise Removal Filter 22)

A noise removal filter 22 removes a high-frequency noise component included in a sin output signal 31 and a cos output signal 32. Therefore, when a self-diagnostic function of an RD converter 20 is diagnosed, it is necessary to make the length of an error state signal input to the RD converter 20 longer than a time width of a noise removed by the noise removal filter 22. Therefore, the error state signal generation unit 11 generates an error state signal longer than the time width, and a fault injection unit 12 inputs the error state signal longer than the time width to the RD converter 20.

Meanwhile, when applying the above principle, an RD converter diagnostic function diagnostic unit 13 can diagnose whether the noise removal filter 22 is normally operated. To be specific, the error state signal generation unit 11 and the fault injection unit 12 input an error state signal shorter than a time width of a noise removed by the noise removal filter 22 to the RD converter 20. If diagnosis results 231 and 251 are both normal, the RD converter diagnostic function diagnostic unit 13 can determine that the noise removal filter 22 is normally operated, and if either the diagnosis result 231 or 251 is abnormal, the RD converter diagnostic function diagnostic unit 13 can determine that the noise removal filter 22 is abnormally operated.

### (Another Diagnosis 2: Another Example of an Error State Signal)

While in FIG. 3 of the first embodiment, the error state signals changing in a step manner have been exemplarily illustrated, a step pulse can be simply superimposed on at least one of the sin output signal 31 and the cos output signal 32. In this case, an error state sin signal 111 and an error state cos signal 112 become in a state where phase shift and amplitude shift are complexly caused. Therefore, whether abnormality is caused in at least one of an input signal diagnostic unit and a calculation function diagnostic unit 25 can be determined.

### Third Embodiment

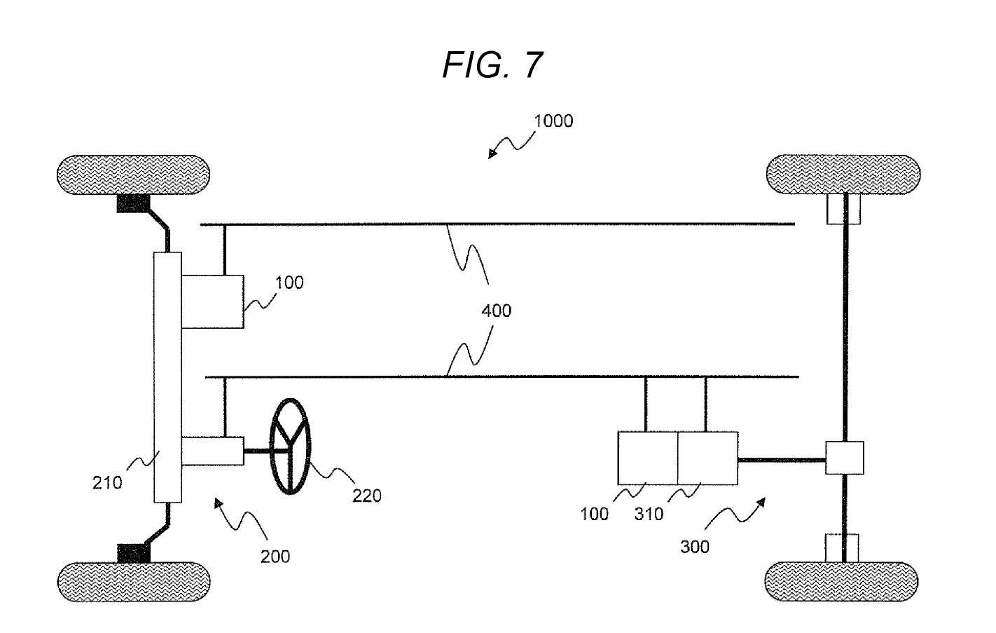

FIG. 7 is a configuration diagram of an electric vehicle 1000 according to a third embodiment of the present invention. The electric vehicle 1000 includes a rotating angle detection system 100, a power steering system 200, and a power train system 300 described in the first and second embodiments. These systems are mutually connected by a vehicle network 400.

The power steering system 200 is a system that controls a traveling direction of the electric vehicle 1000. When a manipulator operates a steering device 220, a motor 210 assists the operation. The power train system 300 is a system that provides wheels of the electric vehicle 1000 with progress power by a motor 310.

The rotating angle detection system 100 detects rotating angles of the motors 210 and 310, and notifies a control device (not illustrated) of the rotating angles. The control device controls the operation of the electric vehicle 1000 according to the rotating angles.

The electric vehicle 1000 according to the third embodiment detects rotating angles by the rotating angle detection system 100 with high reliability, and can improve safety and reliability of the entire system based on the detected rotating angles.

The invention made by the inventors has been specifically described based on the embodiments. However, it goes without saying that the present invention is not limited by the embodiments and various changes can be made without departing from the gist of the invention.

Further, all or a part of the above-described configurations, functions, processing units, and the like can be realized as hardware by designing them with an integrated circuit, for example, or can be realized as software by executing the functions by a processor. Information, such as programs and tables that realize the functions, can be stored in a storage device, such as a memory or a hard disk, or in a storage medium, such as an IC card or a DVD.

### REFERENCE SIGNS LIST

10 diagnostic device
11 error state signal generation unit
12 fault injection unit
13 RD converter diagnostic function diagnostic unit
20 RD converter
21 excitation signal generation unit
211 excitation input signal
212 excitation signal line
22 noise removal filter
23 input signal diagnostic unit
24 angle/angle speed calculation unit
25 calculation function diagnostic unit
30 resolver
31 sin output signal
311 sin output signal line
32 cos output signal
321 cos output signal line
100 rotating angle detection system
200 power steering system
210 motor
220 steering device
300 power train system
310 motor
400 vehicle network
1000 electric vehicle

1. A diagnostic device of an RD converter diagnostic unit configured to diagnose whether a diagnostic unit is normally operated, the diagnostic unit diagnosing an RD converter, the RD converter calculating a detection angle using two output signals of a resolver, the two output signals periodically changing and having different phases, and the resolver expressing the detection angle by the two output signals, the diagnostic device comprising:
an error state signal generation unit configured to generate the output signals that have become in an error state as error state signals, separately from the output signals;
a fault injection unit configured to switch whether either the output signals or the error state signals is input to the RD converter; and
an RD converter diagnostic function diagnostic unit configured to receive a diagnosis result of whether the RD converter is normally operated from the diagnostic unit, and to diagnose whether the diagnostic unit is normally operated based on the diagnosis result,
wherein the RD converter diagnostic function diagnostic unit
determines that the diagnostic unit is normally operated when the fault injection unit inputs the error state signals to the RD converter, and the diagnosis result indicates that the RD converter is abnormally operated, and
determines that the diagnostic unit is abnormally operated when the fault injection unit inputs the error state signals to the RD converter, and the diagnosis result indicates that the RD converter is normally operated.

2. The diagnostic device of an RD converter diagnostic unit according to claim 1, wherein the error state signal generation unit generates the error state signal that has become in an amplitude excessive error state in which the error state signal has a maximum amplitude value larger than a normal maximum amplitude value, regarding at least one of the two output signals.

3. The diagnostic device of an RD converter diagnostic unit according to claim 2, wherein
the diagnostic unit includes an input signal diagnostic unit configured to outputs the diagnosis result that indicates a result of a diagnosis of whether the output signals input to the RD converter are normal, and
the RD converter diagnostic function diagnostic unit determines that the input signal diagnostic unit is abnormally operated when the fault injection unit inputs the error state signal that has becomes in the amplitude excessive error state to the RD converter, and the diagnostic result indicates the output signals are normal.

4. The diagnostic device of an RD converter diagnostic unit according to claim 1, wherein the error state signal generation unit generates the error state signal that has become in an amplitude under error state in which the error state signal has a maximum amplitude value smaller than a normal maximum amplitude value, regarding at least one of the two output signals.

5. The diagnostic device of an RD converter diagnostic unit according to claim 4, wherein
the diagnostic unit includes an input signal diagnostic unit configured to outputs the diagnosis result that indicates a result of a diagnosis of whether the output signals input to the RD converter are normal, and
the RD converter diagnostic function diagnostic unit determines that the input signal diagnostic unit is abnormally operated when the fault injection unit inputs the error state signal that has become in the amplitude under error state to the RD converter, and the diagnostic result indicates that the output signals are normal.

6. The diagnostic device of an RD converter diagnostic unit according to claim 1, wherein the error state signal generation unit generates the error state signal that has become in a step error state in which the error state signal has a portion that changes in a step manner in place of the periodic change, regarding at least one of the two output signals.

7. The diagnostic device of an RD converter diagnostic unit according to claim 6, wherein
the diagnostic unit includes a calculation function diagnostic unit configured to output the diagnosis result that indicates a result of a diagnosis of whether the detection angle calculated by the RD converter is normal, and
the RD converter diagnostic function diagnostic unit determines that the calculation function diagnostic unit is abnormally operated when the fault injection unit inputs the error state signal that has become in the step error state to the RD converter, and the diagnosis result indicates that the detection angle is normal.

8. The diagnostic device of an RD converter diagnostic unit according to claim 1, wherein
the diagnostic unit includes
an input signal diagnostic unit configured to output the diagnostic result that indicates a result of a diagnosis of whether the output signals input to the RD converter are normal, and
a calculation function diagnostic unit configured to output the diagnostic result that indicates a result of a diagnosis of whether the detection angle calculated by the RD converter is normal,
the error state signal generation unit sequentially generates
the error state signal that has become in an amplitude excessive error state in which the error state signal has a maximum amplitude value larger than a normal maximum amplitude value, regarding at least one of the two output signals,
the error state signal that has become in an amplitude under error state in which the error state signal has a maximum amplitude value smaller than a normal maximum amplitude value, regarding at least one of the two output signals, and
the error state signal that has become in a step error state in which the error state signal has a portion that changes in a step manner in place of the periodic change, regarding at least one of the two output signals,
the error state signal injection unit sequentially inputs the error state signal that has become in an amplitude excessive error state, the error state signal that has become in the amplitude under error state, and the error state signal that has become in the step error state to the RD converter, and
the RD converter diagnostic function diagnostic unit
determines that the input signal diagnostic unit is abnormally operated when the fault injection unit inputs the error state signal that has becomes in the amplitude excessive error state to the RD converter, and the diagnostic result indicates the output signals are normal,
determines that the input signal diagnostic unit is abnormally operated when the fault injection unit inputs the error state signal that has become in the amplitude under error state to the RD converter, and the diagnostic result indicates that the output signals are normal, and
determines that the calculation function diagnostic unit is abnormally operated when the fault injection unit inputs the error state signal that has become in the step error state to the RD converter, and the diagnosis result indicates that the detection angle is normal.

9. The diagnostic device of an RD converter diagnostic unit according to claim 1, wherein the error state signal generation unit generates the error state signal that has become in a step superimposition error state in which the error state signal has a portion that superimposes a step pulse in addition to the output signal, regarding at least one of the two output signals.

10. The diagnostic device of an RD converter diagnostic unit according to claim 9, wherein
the diagnostic unit includes
an input signal diagnostic unit configured to output the diagnostic result that indicates a result of a diagnosis of whether the output signals input to the RD converter are normal, and
a calculation function diagnostic unit configured to output the diagnostic result that indicates a result of a diagnosis of whether the detection angle calculated by the RD converter is normal, and
the RD converter diagnostic function diagnostic unit determines that at least one of the input signal diagnostic unit and the calculation function diagnostic unit is abnormally operated when the fault injection unit inputs the error state signal that has become in the step superimposition error state to the RD converter, and the diagnosis result indicates that the output signals and the detection angle are both normal.

11. The diagnostic device of an RD converter diagnostic unit according to claim 1, wherein
the RD converter includes a low-pass filter that removes a high-frequency noise of the output signals, and
the fault injection unit continuously inputs the error state signal to the RD converter for a time longer than a time width of the high-frequency noise removed by the low-pass filter.

12. The diagnostic device of an RD converter diagnostic unit according to claim 1, wherein the RD converter diagnostic function diagnostic unit determines that the low-pass filter is abnormally operated when the error state signal is input to the RD converter for a time shorter than a time width of the high-frequency noise removed by the low-pass filter, and the diagnostic result indicates that the RD converter is abnormally operated.

13. A steering system comprising:
a steering device configured to control a progress direction of a vehicle;
a motor configured to drive the steering device; and
a rotating angle detection system configured to detect a rotating angle of the motor,
wherein the rotating angle detection system includes
the diagnostic device of the RD converter diagnostic unit according to claim 1,
an RD converter configured to calculate an detection angle using two output signals of a resolver that expresses the detection angle by the two output signals that periodically change and have mutually different phases, and
a diagnostic unit configured to diagnose the RD converter, and
the diagnostic device of the RD converter diagnostic unit diagnoses the diagnostic unit.

14. A power train system comprising:
a motor configured to drive wheels of a vehicle; and
a rotating angle detection system configured to detect a rotating angle of the motor,
wherein the rotating angle detection system includes
the diagnostic device of the RD converter diagnostic unit according to claim 1,
an RD converter configured to calculate an detection angle using two output signals of a resolver that expresses the detection angle by the two output signals that periodically change and have mutually different phases, and
a diagnostic unit configured to diagnose the RD converter, and
the diagnostic device of the RD converter diagnostic unit diagnoses the diagnostic unit.
